(19) United States
(12) Patent Application Publication
(10) Pub. No.: US 2024/0377569 A1
(43) Pub. Date: Nov. 14, 2024

(54) DIFFRACTIVE OPTICAL WAVEGUIDE AND PREPARATION METHOD THEREOF, AND AUGMENTED REALITY DISPLAY DEVICE

(71) Applicant: Beijing Zitiao Network Technology Co., Ltd., Beijing (CN)

(72) Inventors: Wei TAN, Beijing (CN); Wen XIONG, Beijing (CN); Hao TANG, Beijing (CN); Xiaokai LI, Beijing (CN)

(21) Appl. No.: 18/658,564

(22) Filed: May 8, 2024

(30) Foreign Application Priority Data
May 8, 2023 (CN) 202310512917.9

(51) Int. Cl. F21V 8/00; G02B 27/01; G02B 27/44

(52) U.S. Cl. CPC G02B 6/0016; G02B 6/0031; G02B 6/0065; G02B 27/0101; G02B 27/44

(57) ABSTRACT

The present invention provides a diffractive optical waveguide and a preparation method thereof, and an augmented reality display device. The diffractive optical waveguide includes: a total reflection layer, wherein the total reflection layer includes a first light propagation layer and a second light propagation layer, which are disposed in a stacked manner, a refractive index of the second light propagation layer is less than a refractive index of the first light propagation layer, and the second light propagation layer is deposited on one surface of the first light propagation layer via a deposition method; and a coupling-in grating and a coupling-out grating, wherein the coupling-in grating and the coupling-out grating are disposed at intervals on a side of the first light propagation layer that faces away from the second light propagation layer.

### CROSS-REFERENCE TO RELATED APPLICATION

This application claims priority to Chinese Application No. 202310512917.9 filed on May 8, 2023, the disclosure of which is incorporated herein by reference in its entity.

### FIELD

The present invention relates to the technical field of display, and in particular to a diffractive optical waveguide and a preparation method thereof, and an augmented reality display device.

### BACKGROUND

Augmented Reality (AR), as a next-generation computing platform, has received widespread attention, an existing optical display technology mainly includes an array waveguide solution, a volume hologram solution, a free-form surface solution, and the like, and a diffractive waveguide solution based on surface relief is considered as one of the mainstream optical display solutions for AR whole-machine products due to its small volume, light weight, high transmittance, a form of being easily made into glasses, and good wearing experience. A diffractive waveguide technology is mainly divided into a one-dimensional architecture and a two-dimensional architecture, a one-dimensional solution includes coupling-in, turning and coupling-out gratings, a two-dimensional solution only includes coupling-in and coupling-out gratings, and the basic principle of the diffractive waveguide technology is that the coupling-in grating couples the light of an optical machine into a waveguide, the light performs total reflection forward propagation within the waveguide and is coupled out after undergoing pupil expansion by the turning grating or the coupling-out grating, and external ambient light and virtual information are fused and finally reach human eyes to function as augmented reality. However, an existing diffractive waveguide still has the technical problem of being non-uniform in color.

### SUMMARY

The present invention aims to solve at least one of the technical problems in the related art to a certain extent. To this end, one objective of the present invention is to provide a diffractive optical waveguide, which may effectively improve propagation distances and exit pupil densities of red, green and blue light in the waveguide, thereby improving the color uniformity.

In one aspect of the present invention, the present invention provides a diffractive optical waveguide. According to an embodiment of the present invention, the diffractive optical waveguide includes a total reflection layer, wherein the total reflection layer includes a first light propagation layer and a second light propagation layer, which are disposed in a stacked manner, a refractive index of the second light propagation layer is less than a refractive index of the first light propagation layer, and the second light propagation layer is deposited on one surface of the first light propagation layer via a deposition method; and a coupling-in grating and a coupling-out grating, wherein the coupling-in grating and the coupling-out grating are disposed at intervals on a side of the first light propagation layer that faces away from the second light propagation layer. Therefore, the total reflection layer includes the first light propagation layer with a high refractive index and the second light propagation layer with a low refractive index, which are disposed in the stacked manner, compared with a single-layer total reflection layer with a high refractive index, the total reflection layer of the present application may enable light to undergo more sufficient total reflection forward propagation in the total reflection layer, that is, light emitted from the first light propagation layer may be reflected in the second light propagation layer, and is coupled out after undergoing pupil expansion by the gratings, thereby improving the color uniformity of the optical waveguide; in addition, the second light propagation layer is deposited on one surface of the first light propagation layer via the deposition method, so that propagation distances and exit pupil densities of red, green and blue light in the waveguide can be effectively improved, thereby improving the color uniformity of the emitted light of the diffractive optical waveguide; moreover, the problems of poor attachment parallelism, bubbles, attachment failure and the like between the second light propagation layer and the first light propagation layer can be avoided, thereby improving the reliability of the total reflection layer; and in addition, since the second light propagation layer is prepared by the deposition method, the deposition thickness and the material type of the second light propagation layer can be quickly controlled, that is, the design flexibility of the second light propagation layer is improved.

According to an embodiment of the present invention, the refractive index of the first light propagation layer ranges from 1.7 to 5.0, and the refractive index of the second light propagation layer ranges from 1 to 1.7.

According to an embodiment of the present invention, the second light propagation layer is of a single-layer structure or a multi-layer structure, the multi-layer structure is a plurality of sub-film layers, which are disposed in the stacked manner, and in a direction away from the first light propagation layer, refractive indexes of the plurality of sub-film layers gradually decrease.

According to an embodiment of the present invention, the first light propagation layer is made from glass or resin, and the second light propagation layer is made from at least one of silicon dioxide, silicon monoxide, magnesium fluoride and aluminum oxide.

According to an embodiment of the present invention, the thickness of the first light propagation layer ranges from 0.1 μm to 5 mm, and the thickness of the second light propagation layer ranges from 50 nm to 2 mm.

According to an embodiment of the present invention, the diffractive optical waveguide further includes a bonding layer and/or an optical functional layer, the bonding layer is disposed on a side of the first light propagation layer that is close to the gratings, and the optical functional layer is disposed on a side of the coupling-in grating and the coupling-out grating that faces away from the first light propagation layer.

According to an embodiment of the present invention, the diffractive optical waveguide satisfies at least one of the following conditions: the thickness of the bonding layer ranges from 0.5 nm to 1 μm; the heights of the coupling-in grating and the coupling-out grating respectively range from 50 nm to 5000 nm; the refractive indexes of the coupling-in grating and the coupling-out grating respectively range from 1.5 to 2.1; the thickness of the optical functional layer ranges from 20 nm to 500 nm; and the optical functional layer is made from titanium dioxide, aluminum, silicon nitride or hafnium dioxide.

In another aspect of the present invention, the present invention provides a method for preparing the above diffractive optical waveguide. According to an embodiment of the present invention, the method for preparing the above diffractive optical waveguide includes: depositing the second light propagation layer on one surface of the first light propagation layer, so as to obtain a total reflection layer, wherein a refractive index of the second light propagation layer is less than a refractive index of the first light propagation layer; and forming the coupling-in grating and the coupling-out grating on a side of the first light propagation layer that faces away from the second light propagation layer. Therefore, the total reflection layer includes the first light propagation layer with a high refractive index and the second light propagation layer with a low refractive index, which are disposed in the stacked manner, compared with a single-layer total reflection layer with a high refractive index, the total reflection layer of the present application may enable light to undergo more sufficient total reflection forward propagation in the total reflection layer, that is, light emitted from the first light propagation layer may be reflected in the second light propagation layer, and is coupled out after undergoing pupil expansion by the gratings, thereby improving the color uniformity of the optical waveguide; in addition, the second light propagation layer is deposited on one surface of the first light propagation layer via the deposition method, so that propagation distances and exit pupil densities of red, green and blue light in the waveguide can be effectively improved, thereby improving the color uniformity of the emitted light of the diffractive optical waveguide; moreover, the problems of poor attachment parallelism, bubbles and the like between the second light propagation layer and the first light propagation layer can be avoided, thereby improving the reliability of the total reflection layer; and in addition, since the second light propagation layer is prepared by the deposition method, the deposition thickness and the material type of the second light propagation layer can be quickly controlled, that is, the design flexibility of the second light propagation layer is improved.

According to an embodiment of the present invention, the method for depositing the second light propagation layer is chemical vapor deposition, physical vapor deposition, or atomic layer deposition.

According to an embodiment of the present invention, the method for preparing the diffractive optical waveguide further includes: performing a polishing treatment on the surface of the second light propagation layer that faces away from the first light propagation layer.

According to an embodiment of the present invention, the method for forming the coupling-in grating and the coupling-out grating is imprinting or etching.

According to an embodiment of the present invention, the method for preparing the above diffractive optical waveguide further includes: forming a bonding layer and/or an optical functional layer, wherein the bonding layer is formed on a side of the first light propagation layer that is close to the gratings, and the optical functional layer is formed on a side of the coupling-in grating and the coupling-out grating that faces away from the first light propagation layer.

In yet another aspect of the present invention, the present invention provides an augmented reality display device. According to an embodiment of the present invention, the augmented reality display device includes the diffractive optical waveguide as described above. The augmented reality display device has good color uniformity. Those skilled in the art can understand that the augmented reality display device has the features and advantages of the diffractive optical waveguide as described above, and thus details are not described herein again.

### BRIEF DESCRIPTION OF THE DRAWINGS

The above and/or additional aspects and advantages of the present invention will become apparent and readily understood from the following description of the embodiments in combination with the drawings, wherein:

FIG. 1 is a schematic structural diagram of a diffractive optical waveguide in one embodiment of the present invention;

FIG. 2 is a schematic structural diagram of a diffractive optical waveguide in another embodiment of the present invention;

FIG. 3 is a schematic structural diagram of a diffractive optical waveguide in yet another embodiment of the present invention;

FIG. 4 is a schematic structural diagram of a diffractive optical waveguide in yet another embodiment of the present invention;

FIG. 5 is a schematic structural diagram of preparing a diffractive optical waveguide in yet another embodiment of the present invention;

FIG. 6 is a schematic structural diagram of preparing a diffractive optical waveguide in yet another embodiment of the present invention; and

FIG. 7 is a schematic diagram of cutting the outline of a waveguide sheet according to yet another embodiment of the present invention.

### DETAILED DESCRIPTION OF EMBODIMENTS

The solutions of the present invention will be explained below in combination with the embodiments. Those skilled in the art will understand that the following embodiments are only used for illustrating the present invention, and should not be considered as limiting the scope of the present invention. If specific techniques or conditions are not indicated in the embodiments, the present invention is implemented according to techniques or conditions described in the literature in the art or according to a product specification. If manufacturers of reagents or instruments used are not indicated, the reagents or instruments may all conventional products commercially available.

The present invention is described below with reference to specific embodiments, and it should be noted that these embodiments are merely illustrative and are not intended to limit the present invention in any way.

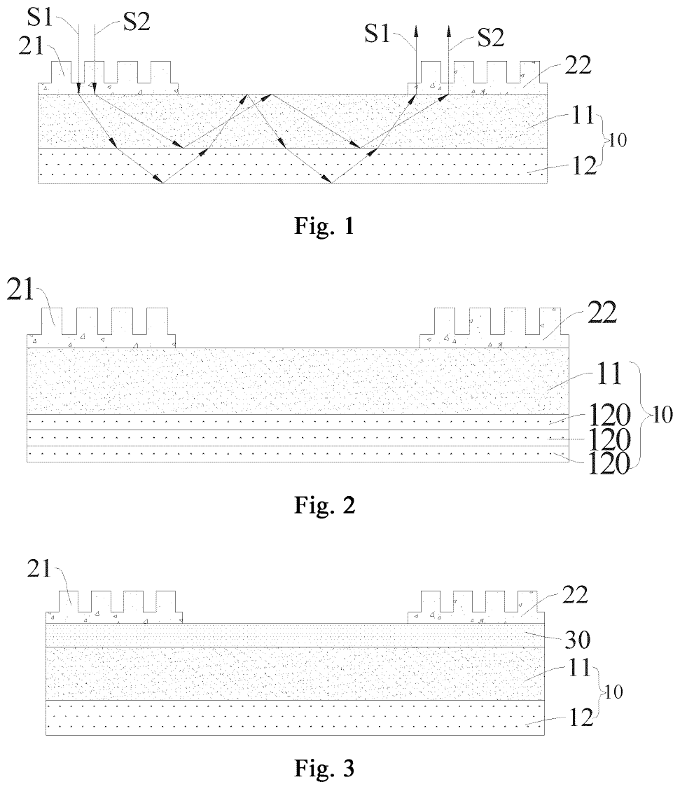

In one aspect of the present invention, the present invention provides a diffractive optical waveguide. According to an embodiment of the present invention, referring to FIG. 1, the diffractive optical waveguide includes a total reflection layer 10, wherein the total reflection layer 10 includes a first light propagation layer 11 and a second light propagation layer 12, which are disposed in a stacked manner, a refractive index of the second light propagation layer 12 is less than a refractive index of the first light propagation layer 11, and the second light propagation layer 12 is deposited on one surface of the first light propagation layer 11 via a deposition method; and a coupling-in grating 21 and a coupling-out grating 22, wherein the coupling-in grating 21 and the coupling-out grating 22 are disposed at intervals on a side of the first light propagation layer 11 that faces away from the second light propagation layer 12. Therefore, the total reflection layer 10 includes the first light propagation layer 11 with a high refractive index and the second light propagation layer 12 with a low refractive index, which are disposed in the stacked manner, compared with a single-layer total reflection layer with a high refractive index, the total reflection layer of the present application may enable light to undergo more sufficient total reflection forward propagation in the total reflection layer, that is, light emitted from the first light propagation layer 11 may be reflected in the second light propagation layer 12, and is coupled out after undergoing pupil expansion by the gratings, thereby improving the color uniformity of the optical waveguide; in addition, the second light propagation layer 12 is deposited on one surface of the first light propagation layer 11 via the deposition method, so that propagation distances and exit pupil densities of red, green and blue light in the waveguide can be effectively improved, thereby improving the color uniformity of the emitted light of the diffractive optical waveguide; moreover, the problems of poor attachment parallelism, bubbles, attachment failure and the like between the second light propagation layer 12 and the first light propagation layer 11 can be avoided, thereby improving the reliability of the total reflection layer; and in addition, since the second light propagation layer 12 is prepared by the deposition method, the deposition thickness and the material type of the second light propagation layer 12 can be quickly controlled, that is, the design flexibility of the second light propagation layer 12 is improved.

If the second light propagation layer 12 with the low refractive index is attached to or bonded to the surface of the first light propagation layer 11 with the high refractive index by using an attachment process or a bonding process, during an attachment process, it is prone to the problems of uneven attachment and bubbles between the second light propagation layer 12 and the first light propagation layer 11, resulting in more serious color separation; and in a bonding process, the surface roughness of the waveguide is increased during a surface treatment process of the second light propagation layer 12 and the first light propagation layer 11, and an efficacy is likely to occur after bonding, such that the second light propagation layer 12 is separated from the first light propagation layer 11. In the present application, since the second light propagation layer 12 is deposited on one surface of the first light propagation layer 11 via the deposition method, the above technical problems occurring in the above two processes can be effectively avoided, that is, the problems of attachment parallelism, bubbles, separation and the like between the second light propagation layer 12 and the first light propagation layer 11 can be avoided, thereby improving the reliability of the total reflection layer.

A propagation path of the light in the diffractive optical waveguide may refer to FIG. 1, light S1 enters the first light propagation layer 11 via the coupling-in grating 21, then is refracted to the second light propagation layer 12, is reflected back into the first light propagation layer 11 on a bottom surface of the second light propagation layer 12, and then is reflected on a top surface of the first light propagation layer 11 to enter the second light propagation layer 12 again (that is, the light S1 is propagated in the first light propagation layer 11 and the second light propagation layer 12), and the light S1 is propagated in the total reflection layer 10 according to the above path in a direction close to the coupling-out grating 22, until the light S1 is emitted from the first light propagation layer 11 via the coupling-out grating 22 (it is only taken as an example in the figure that the light S1 undergoes three times of total reflection in the total reflection layer 10, but the propagation path of the light S1 is not limited thereto); and light S2 enters the first light propagation layer 11 via the coupling-in grating 21 and is reflected on the bottom surface of the first light propagation layer 11, when the light S2 irradiates the top surface of the first light propagation layer 11, the light S2 is reflected on the top surface of the first light propagation layer 11 (that is, the light S2 is only propagated in the first light propagation layer 11), and the light S2 is propagated in the total reflection layer 10 according to the above path in the direction close to the coupling-out grating 22, until the light S2 is emitted from the first light propagation layer 11 via the coupling-out grating 22 (it is only taken as an example in the figure that the light S2 undergoes three times of reflection in the total reflection layer 10, but the propagation path of the light S2 is not limited thereto).

According to an embodiment of the present invention, a refractive index of the first light propagation layer 11 ranges from 1.7 to 5.0 (e.g., 1.7, 2.0, 2.2, 2.5, 2.8, 3.0, 3.3, 3.5, 3.8, 4.0, 4.3, 4.5, 4.7 and 5.0), and a refractive index of the second light propagation layer 12 ranges from 1 to 1.7 (e.g., 1, 1.1, 1.2, 1.3, 1.4, 1.5, 1.6 and 1.7). The second light propagation layer 12 and the first light propagation layer 11 with the above refractive indexes may fully enable red, green and blue light to be totally reflected in the total reflection layer, thereby improving the color uniformity of the optical waveguide.

According to an embodiment of the present invention, the second light propagation layer 12 is of a single-layer structure (as shown in FIG. 1) or a multi-layer structure (as shown in FIG. 2), the multi-layer structure is a plurality of sub-film layers 120, which are disposed in the stacked manner (three layers are taken as an example in FIG. 2), and in a direction away from the first light propagation layer 11, refractive indexes of the plurality of sub-film layers 120 gradually decrease. Therefore, the light can further undergo more sufficient total reflection in the total reflection film layer, and the refraction of the light from the bottom surface of the total reflection layer is reduced, and thereby improving the coupling-out rate of the light.

According to an embodiment of the present invention, the first light propagation layer is made from glass or resin, and the second light propagation layer is made from at least one of silicon dioxide, silicon monoxide, magnesium fluoride and aluminum oxide. The above materials may well realize total reflection of light.

According to an embodiment of the present invention, the thickness of the first light propagation layer ranges from 0.1 μm to 5 mm (e.g., 0.1 μm, 0.5 μm, 1 μm, 10 μm, 20 μm, 50 μm, 80 μm, 100 μm, 300 μm, 500 μm, 800 μm, 1 mm, 1.3 mm, 1.5 mm, 1.8 mm, 2.0 mm, 2.3 mm, 2.5 mm, 2.7 mm, 3.0 mm, 3.5 mm, 4.0 mm, 4.5 mm and 5.0 mm), and the thickness of the second light propagation layer ranges from 50 nm to 2 mm (e.g., 50 nm, 100 nm, 300 nm, 500 nm, 800 nm, 1 μm, 50 μm, 100 μm, 300 μm, 500 μm, 800 μm, 1 mm, 1.3 mm, 1.5 mm, 1.8 mm and 2.0 mm). The above thicknesses may effectively realize the propagation of light in the total reflection layer.

According to an embodiment of the present invention, the heights of the coupling-in grating and the coupling-out grating respectively range from 50 nm to 5000 nm (e.g., 50 nm, 100 nm, 200 nm, 500 nm, 800 nm, 1000 nm, 1500 nm, 2000 nm, 2500 nm, 3000 nm, 3500 nm, 4000 nm, 4500 nm and 5000 nm); and the refractive indexes of the coupling-in grating and the coupling-out grating respectively range from 1.5 to 2.1. The coupling-in grating and the coupling-out grating required above may effectively satisfy the usage requirements of the diffractive optical waveguide and improve the usage performance of the diffractive optical waveguide.

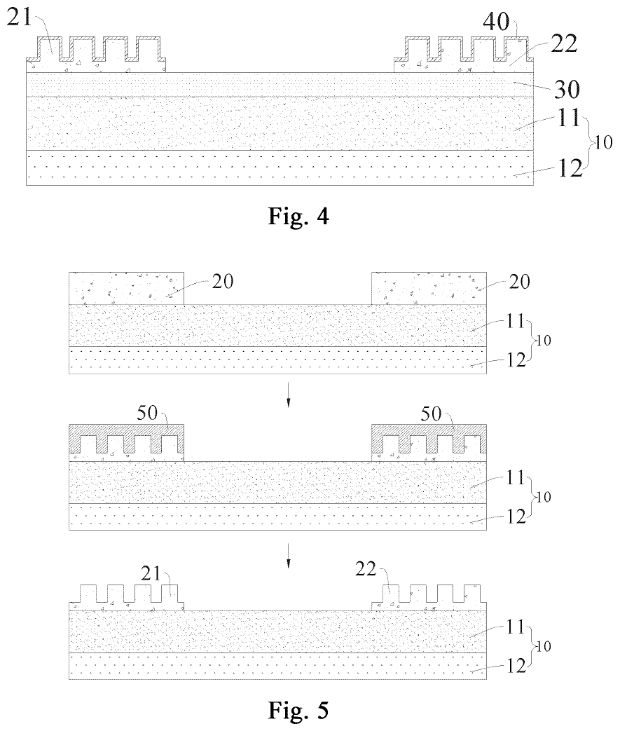

According to an embodiment of the present invention, referring to FIG. 3 and FIG. 4, the diffractive optical waveguide further includes a bonding layer 30 and/or an optical functional layer 40, the bonding layer 30 is disposed on a side of the first light propagation layer 11 that is close to the gratings (including the coupling-in grating 21 and the coupling-out grating 22), and the optical functional layer 40 is disposed on a side of the coupling-in grating 21 and the coupling-out grating 22 that faces away from the first light propagation layer 11. By disposing the bonding layer, a bonding force of the coupling-in grating and the coupling-out grating with the total reflection layer can be well improved, thereby improving the stability of the overall structure of the diffractive optical waveguide; and by disposing the optical functional layer, the diffraction efficiency of the coupling-in grating and the coupling-out grating can be further improved.

The thickness of the bonding layer ranges from 0.5 nm to 1 μm, for example, 0.5 nm, 0.8 nm, 0.9 nm, 1.0 nm, 1.2 nm, 1.5 nm, 1.7 nm, 2.0 nm, 10 nm, 100 nm, 300 nm, 500 nm, 800 nm or 1 μm. The bonding layer has a relatively small thickness and very good bonding performance. There is no special requirement for the specific material of the bonding layer, and those skilled in the art can make flexible choice according to actual requirements, which is not limited herein.

The thickness of the optical functional layer ranges from 20 nm to 500 nm, for example, 20 nm, 50 nm, 80 nm, 100 nm, 150 nm, 200 nm, 250 nm, 300 nm, 350 nm, 400 nm, 450 nm, and 500 nm; and further, the optical functional layer is made from titanium dioxide, aluminum, silicon nitride or hafnium dioxide.

In another aspect of the present invention, the present invention provides a method for preparing the above diffractive optical waveguide. According to an embodiment of the present invention, the method for preparing the above diffractive optical waveguide includes: depositing the second light propagation layer 12 on one surface of the first light propagation layer 11, so as to obtain the total reflection layer 10, wherein a refractive index of the second light propagation layer 12 is less than a refractive index of the first light propagation layer 11; and forming the coupling-in grating 21 and the coupling-out grating 22 on a side of the first light propagation layer 11 that faces away from the second light propagation layer 12. Therefore, the total reflection layer 10 includes the first light propagation layer 11 with a high refractive index and the second light propagation layer 12 with a low refractive index, which are disposed in the stacked manner, compared with a single-layer total reflection layer with a high refractive index, the total reflection layer of the present application may enable light to undergo more sufficient total reflection forward propagation in the total reflection layer, that is, at least light emitted from the first light propagation layer 11 may be reflected in the second light propagation layer 12, and is coupled out after undergoing pupil expansion by the gratings, thereby improving the color uniformity of the optical waveguide; in addition, the second light propagation layer 12 is deposited on one surface of the first light propagation layer 11 via the deposition method, so that propagation distances and exit pupil densities of red, green and blue light in the waveguide can be effectively improved, thereby improving the color uniformity of the emitted light of the diffractive optical waveguide; moreover, the problems of poor attachment parallelism, bubbles, attachment failure and the like between the second light propagation layer 12 and the first light propagation layer 11 can be avoided, thereby improving the reliability of the total reflection layer; and in addition, since the second light propagation layer 12 is prepared by the deposition method, the deposition thickness and the material type of the second light propagation layer 12 can be quickly controlled, that is, the design flexibility of the second light propagation layer 12 is improved.

According to an embodiment of the present invention, the method for depositing the second light propagation layer is chemical vapor deposition (CVD), physical vapor deposition (PVD), or atomic layer deposition (ALD), wherein the chemical vapor deposition may employ plasma enhanced chemical vapor deposition (PECVD). The above process is relatively mature, and may well avoid the problems of poor attachment parallelism, bubbles, attachment failure and the like between the second light propagation layer 12 and the first light propagation layer 11, thereby improving the reliability of the total reflection layer; and in addition, the deposition thickness and the material type of the second light propagation layer 12 can be quickly controlled by the process, that is, the design flexibility of the second light propagation layer 12 is improved.

According to an embodiment of the present invention, the method for preparing the diffractive optical waveguide further includes: performing a polishing treatment on the surface of the second light propagation layer 12 that faces away from the first light propagation layer 11. As such, in the polishing treatment, not only can the flatness of the surface of the second light propagation layer 12 be optimized, but the second light propagation layer 12 can also be appropriately thinned, that is, the thickness of the second light propagation layer 12 and the flatness of the surface may be optimized by the polishing treatment, thereby further improving the color uniformity of the diffractive optical waveguide. The specific process of the polishing treatment may employ a chemical mechanical polishing (CMP) process, which has higher precision and is convenient for industrial production.

According to an embodiment of the present invention, the method for forming the coupling-in grating and the coupling-out grating is imprinting or etching, the imprinting or etching method may effectively obtain the coupling-in grating and the coupling-out grating with higher precision, specifically:
in some embodiments, the coupling-in grating and the coupling-out grating are prepared by using an imprinting method, referring to FIG. 5, including: coating a layer of imprinting adhesive material 20 on a position where the coupling-in grating and the coupling-out grating need to be formed on a side of the first light propagation layer 11 that faces away from the second light propagation layer 12; and then, imprinting the imprinting adhesive material 20 by using an imprint template 50 to transfer a pattern of the imprint template 50 to the imprinting adhesive material 20, and obtaining the coupling-in grating 21 and the coupling-out grating 22 by exposure and demolding, wherein an ultraviolet exposure method may be used, and the wavelength of the ultraviolet light may be 365 nm.

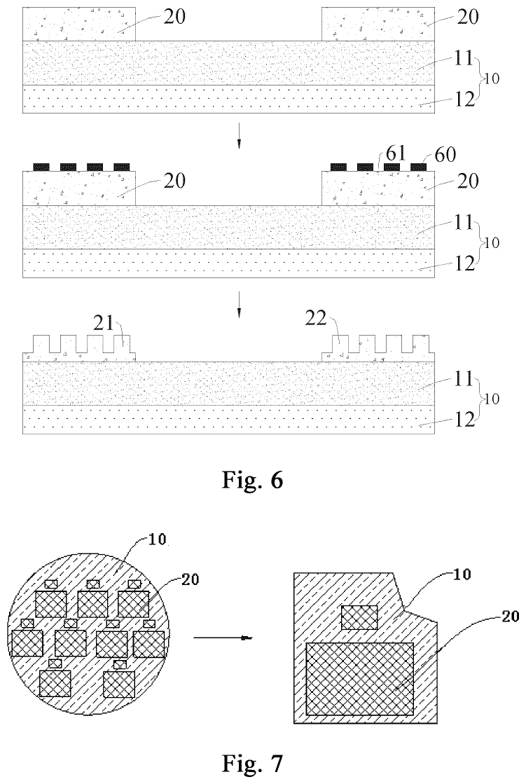

In some other embodiments, the coupling-in grating and the coupling-out grating are prepared by using an etching method, referring to FIG. 6, including: coating a layer of imprinting adhesive material 20 on a position where the coupling-in grating and the coupling-out grating need to be formed on a side of the first light propagation layer 11 that faces away from the second light propagation layer 12; and coating photoresist 60 above the imprinting adhesive material 20, exposing an opening 61 of the photoresist 60 and not exposing remaining positions, and then obtaining the coupling-in grating 21 and the coupling-out grating 22 by development, etching, cleaning and other steps.

The process of coating the imprinting adhesive material 20 in the above two methods may be spin coating, ink jet printing (IJP), split (Split) and other methods, which is mature in process and high in manufacturing precision.

According to an embodiment of the present invention, referring to FIG. 3 and FIG. 4, the method for preparing the above diffractive optical waveguide further includes: forming a bonding layer 30 and/or an optical functional layer 40, wherein the bonding layer 30 is formed on a side of the first light propagation layer 11 that is close to the gratings, and the optical functional layer 40 is formed on a side of the coupling-in grating 21 and the coupling-out grating 22 that faces away from the first light propagation layer 11. By disposing the bonding layer, a bonding force of the coupling-in grating and the coupling-out grating with the total reflection layer can be well improved, thereby improving the stability of the overall structure of the diffractive optical waveguide is improved; and by disposing the optical functional layer, the diffraction efficiency of the coupling-in grating and the coupling-out grating can be further improved.

The bonding layer may be formed by coating methods such as spin coating, ink jet printing (IJP) and split (Split), so that the process is mature and the manufacturing precision is high. In some embodiments, the optical functional layer 40 may be formed by using a deposition method, and specifically, the optical functional layer 40 may be formed by using the deposition method, such as chemical vapor deposition (CVD), physical vapor deposition (PVD), or atomic layer deposition (ALD), wherein the chemical vapor deposition may employ plasma enhanced chemical vapor deposition (PECVD).

According to an embodiment of the present invention, referring to FIG. 7, the outline of a waveguide sheet may also be cut according to product requirements, so as to form a plurality of waveguide sheets, each waveguide sheet has a grating 20, and the grating 20 includes the coupling-in grating and the coupling-out grating as described above. Specifically, the cutting may be performed in at least one of picosecond laser cutting or carbon dioxide laser splitting or numerical control cutting.

In yet another aspect of the present invention, the present invention provides an augmented reality display device. According to an embodiment of the present invention, the augmented reality display device includes the diffractive optical waveguide as described above. The augmented reality display device has good color uniformity. Those skilled in the art can understand that the augmented reality display device has the features and advantages of the diffractive optical waveguide as described above, and thus details are not described herein again.

The terms “first” and “second” are used herein for description purpose only, and cannot to be construed as indicating or implying relative importance or implicitly indicating the number of indicated technical features. Thus, the features defined with “first” and “second” may explicitly or implicitly include one or more of the features. In the description of the present application, “a plurality of” means two or more, unless specifically defined otherwise.

In the description of the present specification, description with reference to the terms “one embodiment”, “some embodiments”, “an example”, “a specific example”, or “some examples” means that specific features, structures, materials or characteristics described in combination with the embodiment or example are included in at least one embodiment or example of the present invention. In the present specification, schematic expressions of the above terms are not necessarily directed to the same embodiment or example. Furthermore, the described specific features, structures, materials or characteristics may be combined in any suitable manner in any one or more embodiments or examples. In addition, different embodiments or examples described in the present specification and features of different embodiments or examples may be combined by those skilled in the art without contradicting each other.

Although the embodiments of the present invention have been shown and described above, it can be understood that the above embodiments are exemplary and cannot be construed as limiting the present invention, and those ordinary skilled in the art may made changes, modifications, replacements and variations to the above embodiments within the scope of the present invention.

I/We claim:

1. A diffractive optical waveguide, comprising:
a total reflection layer, wherein the total reflection layer comprises a first light propagation layer and a second light propagation layer, which are disposed in a stacked manner, a refractive index of the second light propagation layer is less than a refractive index of the first light propagation layer, and the second light propagation layer is deposited on one surface of the first light propagation layer via a deposition method; and
a coupling-in grating and a coupling-out grating, wherein the coupling-in grating and the coupling-out grating are disposed at intervals on a side of the first light propagation layer that faces away from the second light propagation layer.

2. The diffractive optical waveguide according to claim 1, wherein the refractive index of the first light propagation layer ranges from 1.7 to 5.0, and the refractive index of the second light propagation layer ranges from 1 to 1.7.

3. The diffractive optical waveguide according to claim 1, wherein the second light propagation layer is of a single-layer structure or a multi-layer structure, the multi-layer structure is a plurality of sub-film layers, which are disposed in the stacked manner, and in a direction away from the first light propagation layer, refractive indexes of the plurality of sub-film layers gradually decrease.

4. The diffractive optical waveguide according to claim 1, wherein the first light propagation layer is made from glass or resin, and the second light propagation layer is made from at least one of silicon dioxide, silicon monoxide, magnesium fluoride and aluminum oxide.

5. The diffractive optical waveguide according to claim 1, wherein the thickness of the first light propagation layer ranges from 0.1 μm to 5 mm, and the thickness of the second light propagation layer ranges from 50 nm to 2 mm.

6. The diffractive optical waveguide according to claim 1, further comprising a bonding layer and/or an optical functional layer, wherein the bonding layer is disposed on a side of the first light propagation layer that is close to the gratings, and the optical functional layer is disposed on a side of the coupling-in grating and the coupling-out grating that faces away from the first light propagation layer.

7. The diffractive optical waveguide according to claim 6, wherein at least one of the following conditions are satisfied:
the thickness of the bonding layer ranges from 0.5 nm to 1 μm;
the heights of coupling-in grating and the coupling-out grating respectively range from 50 nm to 5000 nm;
the refractive index of the coupling-in grating and the coupling-out grating respectively range from 1.5 to 2.1;
the thickness of the optical functional layer ranges from 20 nm to 500 nm; and
the optical functional layer is made from titanium dioxide, aluminum, silicon nitride or hafnium dioxide.

8. A method for preparing a diffractive optical waveguide, comprising:
depositing a second light propagation layer on one surface of a first light propagation layer, so as to obtain a total reflection layer, wherein a refractive index of the second light propagation layer is less than a refractive index of the first light propagation layer; and
forming a coupling-in grating and a coupling-out grating on a side of the first light propagation layer that faces away from the second light propagation layer.

9. The method according to claim 8, wherein the method for depositing the second light propagation layer is chemical vapor deposition, physical vapor deposition, or atomic layer deposition.

10. The method according to claim 8, further comprising: performing a polishing treatment on a surface of the second light propagation layer that faces away from the first light propagation layer.

11. The method according to claim 8, wherein the method for forming the coupling-in grating and the coupling-out grating is imprinting or etching.

12. The method according to claim 8, further comprising the step of forming a bonding layer and/or an optical functional layer, wherein the bonding layer is formed on a side of the first light propagation layer that is close to the gratings, and the optical functional layer is formed on a side of the coupling-in grating and the coupling-out grating that faces away from the first light propagation layer.

13. An augmented reality display device, comprising a diffractive optical waveguide, wherein the diffractive optical waveguide comprises:
a total reflection layer, wherein the total reflection layer comprises a first light propagation layer and a second light propagation layer, which are disposed in a stacked manner, a refractive index of the second light propagation layer is less than a refractive index of the first light propagation layer, and the second light propagation layer is deposited on one surface of the first light propagation layer via a deposition method; and
a coupling-in grating and a coupling-out grating, wherein the coupling-in grating and the coupling-out grating are disposed at intervals on a side of the first light propagation layer that faces away from the second light propagation layer.

14. The augmented reality display device according to claim 13, wherein the refractive index of the first light propagation layer ranges from 1.7 to 5.0, and the refractive index of the second light propagation layer ranges from 1 to 1.7.

15. The augmented reality display device according to claim 13, wherein the second light propagation layer is of a single-layer structure or a multi-layer structure, the multi-layer structure is a plurality of sub-film layers, which are disposed in the stacked manner, and in a direction away from the first light propagation layer, refractive indexes of the plurality of sub-film layers gradually decrease.

16. The augmented reality display device according to claim 13, wherein the first light propagation layer is made from glass or resin, and the second light propagation layer is made from at least one of silicon dioxide, silicon monoxide, magnesium fluoride and aluminum oxide.

17. The augmented reality display device according to claim 13, wherein the thickness of the first light propagation layer ranges from 0.1 μm to 5 mm.

18. The augmented reality display device according to claim 13, wherein the thickness of the second light propagation layer ranges from 50 nm to 2 mm.

19. The augmented reality display device according to claim 13, wherein the diffractive optical waveguide further comprises a bonding layer and/or an optical functional layer, wherein the bonding layer is disposed on a side of the first light propagation layer that is close to the gratings, and the optical functional layer is disposed on a side of the coupling-in grating and the coupling-out grating that faces away from the first light propagation layer.

20. The augmented reality display device according to claim 19, wherein at least one of the following conditions are satisfied:
the thickness of the bonding layer ranges from 0.5 nm to 1 μm;
the heights of coupling-in grating and the coupling-out grating respectively range from 50 nm to 5000 nm;
the refractive index of the coupling-in grating and the coupling-out grating respectively range from 1.5 to 2.1;
the thickness of the optical functional layer ranges from 20 nm to 500 nm; and
the optical functional layer is made from titanium dioxide, aluminum, silicon nitride or hafnium dioxide.
